(19) United States
(12) Patent Application Publication
(10) Pub. No.: US 2009/0167523 A1
(43) Pub. Date: Jul. 2, 2009

(54) SELF-POSITIONING REMOTE BURGLARY ALARM SYSTEM

(75) Inventor: Lei SONG, Beijing (CN)

Correspondence Address: YING CHEN;Chen Yoshimura LLP, 255 S. GRAND AVE., # 215, LOS ANGELES, CA, 90012, US

(73) Assignee: BEIJING RUTIAN SCIENCE AND TECHNOLOGY CO., LTD, Beijing (CN)

(21) Appl. No.: 12/117,979

(22) Filed: May 9, 2008

(30) Foreign Application Priority Data
Dec. 29, 2007 (CN) 200710304721.1

(51) Int. Cl. G08B 1/08; H04Q 7/00

(52) U.S. Cl. 340/539.2; 340/539.22

(57) ABSTRACT

The invention relates to a self-positioning remote burglary alarm system comprising a plurality of sensors used for collecting signals related to burglary, a signal collecting and converting circuit used for receiving and converting signals collected by the sensors, a GPS signal receiving module used for getting a real-time geographical location coordinates information, a microcomputer used for generating alarm information codes, a communication module, a modem and a mobile phone. The invention sends alarm information to a control center or relevant personnel when collecting signals related to burglary.

### BACKGROUND OF THE INVENTION

1. Field of the Invention

The invention relates to a remote burglary alarm system, in particular to a remote burglary alarm system that can prompt the position where the articles are stolen.

2. Description of the Related Art

With respect to the movable articles or the carried articles being stolen, the self-positioning of the alarm system is very essential, which enables the relevant personnel to rapidly discover the burglary and then arrive at the site to get back the stolen articles and capture the thief, so the self-positioning of the anti-theft alarm system is very essential. However, currently people have not paid enough attention to the self-positioning of the alarm system, when making full use of the public data communication system to give a remote alarm. For instance, a remote burglary alarm system can comprises a sensor, a signal treatment circuit, a microcomputer, a wireless data receiving and emitting module, a monitoring center, a personal mobile phone and a public data communication network. The sensor, the signal treatment circuit and the microcomputer are electrically connected with each other, while the microcomputer is connected with the wireless data receiving and emitting module through the serial port. The monitoring center consists of a modem and a main control computer. The modem enables the wireless data receiving and emitting module to be electrically connected with the computer of the control center through the public data communication network. The personal mobile phone is directly communicated with the wireless data receiving and emitting module through the public data communication network. This system only gives a remote alarm, but if the thief takes away the stolen articles, this alarm system cannot provide the position where the articles are stolen.

### SUMMARY OF THE INVENTION

In order to overcome the defects of the prior art, the invention provides a self-positioning remote burglary alarm system, which not only can conduct burglary alarm, but also can realize self-positioning, sending out a position signal of the stolen articles automatically while giving a burglary alarm.

The technical solution of this invention to achieve above purposes is: a self-positioning remote burglary alarm system, comprising a plurality of sensors, used for collecting signals related to burglary; a signal collecting and converting circuit, used for receiving signals collected by the sensors, filtering the signals, converting the signals from analog signals to digital ones and then, sending the signals to a microcomputer; a GPS signal receiving module, used for receiving GPS signals and converting the GPS signals into a real-time geographical location coordinates information and then, sending the information to the microcomputer; the microcomputer, used for automatically generating alarm information codes according to the digital signals related to burglary sent by the signal collecting and converting circuit and then sending the alarm information codes to a communication module, wherein the alarm information codes comprise a user information code, a sensor signal code, a time code and a code of the geographical coordinates; the communication module, used for converting and modulating the alarm information codes according to a communication protocol and then, sending the alarm information codes to a public data information network; a modem, used for receiving and decoding the modulated alarm information codes sent by the public data communication network and then sending the decoded alarm information codes to a central computer; and a mobile phone, used for receiving the modulated alarm information codes sent by the public data communication network and conduct a text display and/or a voice prompt.

The main beneficial effects of the invention is: the relevant burglary information collected by the sensors is processed by the microcomputer and then is automatically sent to the control center or the mobile phone of relevant personnel through the public data communication network, so the control center and the other relevant personnel can connect the burglary information immediately and take the measures timely to prevent and stop the burglary so as to avoid the loss brought by burglary; the GPS signal receiving module automatically obtains the position of anti-theft system and sends the alarm information to the control center or relevant personnel when giving an alarm, so that the relevant personnel can control the position where the articles are stolen at any moment and rapidly arrive at the site.

### BRIEF DESCRIPTION OF THE DRAWING

FIG. 1 is the schematic view of an embodiment of the invention.

### DETAILED DESCRIPTION OF THE PREFERRED EMBODIMENTS

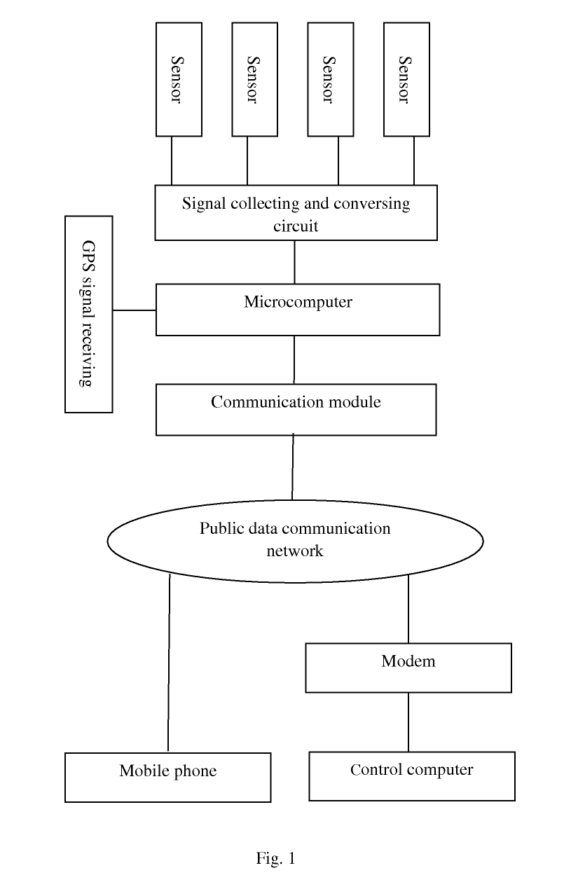

Refer to FIG. 1, this invention relates to a self-positioning remote burglary alarm system comprises a plurality of sensors, a signal collecting and converting circuit, a GPS signal receiving module, a microcomputer, a communication module, a monitoring center and/or a mobile phone and realizes communication through the prior public data network. The GPS signal receiving module is connected with the input port of the microcomputer to receive the GPS signal and convert the GPS signal into the real-time geographical location coordinates information, which is sent to the microcomputer. The microcomputer is connected with the communication module through the serial port and then is connected to the public data communication network through the communication module. The monitoring center consists of a modem and a main control computer. The main control computer is connected with the public data communication network through the modem. The communication module and the modem realize intercommunion through the public data communication network. The mobile phone is communicated with the communication module through the public data communication network.

The sensor can comprise various devices with electric on-off characteristics such as infrared sensor, camera, door magnetic switch, contact sensor, travel sensor, vernier sensor, short connection, plug sensor and mercury sensor.

The communication module may be a GSM communication module, a GPRS communication module and a CDMA communication module. The public data communication network may be a GSM wireless data communication network, a GPRS wireless data communication network and a CDMA wireless data communication network. The communication module chooses any one of the GSM communication module, GPRS communication module and CDMA communication module and the corresponding GSM, GPRS and CDMA data communication networks.

It will be apparent to those skilled in the art that various modification and variations can be made in the device of the present invention without departing from the spirit or scope of the invention. Thus, it is intended that the present invention cover modifications and variations that come within the scope of the appended claims and their equivalents.

What is claimed is:

1. A self-positioning remote burglary alarm system, comprising:
a plurality of sensors for collecting signals related to burglary;
a signal collecting and converting circuit for receiving signals collected by the sensors, filtering the signals, converting the signals from analog signals to digital ones and sending the signals to a microcomputer;
a GPS signal receiving module for receiving GPS signals and converting the GPS signals into a real-time geographical location coordinates information and sending the information to the microcomputer;
the microcomputer for automatically generating alarm information codes according to the digital signals related to burglary sent by the signal collecting and converting circuit and sending the alarm information codes to a communication module, wherein the alarm information codes comprise a user information code, a sensor signal code, a time code and a code of the geographical coordinates;
the communication module for converting and modulating the alarm information codes according to a communication protocol and sending the alarm information codes to a public data information network;
a modem for receiving and decoding the modulated alarm information codes sent by the public data communication network and sending the decoded alarm information codes to a central computer; and
a mobile phone for receiving the modulated alarm information codes sent by the public data communication network and presenting a text display and/or a voice prompt.

2. The system of claim 1, wherein the sensors include infrared sensors.

3. The system of claim 1, wherein the sensors include cameras.

4. The system of claim 1, wherein the sensors include door-magnetic sensors.

5. The system of claim 1, wherein the sensors include mechanical on-off switches.

6. The system of claim 1, wherein the sensors include one or more sensors selected from a group comprising infrared sensors, cameras, image identification circuits, door-magnetic switches and mechanical on-off switches.

7. The system of claim 1, wherein the communication module is a GPS communication module and the public data communication network is a GPS wireless data communication network.

8. The system of claim 1, wherein the communication module is a GSM communication module and the public data communication network is a GSM wireless data communication network.

9. The system of claim 1, wherein the communication module is a GPRS communication module and the public data communication network is a GPRS wireless data communication network.

10. The system of claim 1, wherein the communication module is a CDMA communication module and the public data communication network is a CDMA wireless data communication network.

11. The system of claim 2, wherein the communication module is a GPS communication module and the public data communication network is a GPS wireless data communication network.

12. The system of claim 2, wherein the communication module is a GSM communication module and the public data communication network is a GSM wireless data communication network.

13. The system of claim 2, wherein the communication module is a GPRS communication module and the public data communication network is a GPRS wireless data communication network.

14. The system of claim 2, wherein the communication module is a CDMA communication module and the public data communication network is a CDMA wireless data communication network.

15. The system of claim 6, wherein the communication module is a GPS communication module and the public data communication network is a GPS wireless data communication network.

16. The system of claim 6, wherein the communication module is a GSM communication module and the public data communication network is a GSM wireless data communication network.

17. The system of claim 6, wherein the communication module is a GPRS communication module and the public data communication network is a GPRS wireless data communication network.

18. The system of claim 6, wherein the communication module is a CDMA communication module and the public data communication network is a CDMA wireless data communication network.
